(19) United States
(12) Patent Application Publication
(10) Pub. No.: US 2023/0156300 A1
(43) Pub. Date: May 18, 2023

(54) METHODS AND SYSTEMS FOR MODIFYING CONTENT

(71) Applicant: Comcast Cable Communications, LLC, Philadelphia, PA (US)

(72) Inventor: Arpit MATHUR, Philadelphia, PA (US)

(21) Appl. No.: 17/526,669

(22) Filed: Nov. 15, 2021

(51) Int. Cl. H04N 21/858; H04N 21/81

(52) U.S. Cl. CPC H04N 21/8583; H04N 21/812

(57) ABSTRACT

Methods and systems for content modification are described. A computing device may determine a surface (e.g., a surface of an object) in primary content. The computing device may determine the surface is a candidate for placement of secondary content. The computing device may determine one or more output parameters associated with the surface. The computing device may adjust an output parameter of the one or more output parameters of the surface so as to optimize the surface for placement of the secondary content.

### BACKGROUND

Video content, such as movies and television programs, may include product placements. A product placement may be a placement of a particular product or product identifier, such as a logo or a slogan, in a scene of the content. Product placements may serve as advertisements embedded within content. However, traditional product placement involves placement of a physical object with an advertisement (logo, slogan, etc.) into a scene during filming. Depending on the scene, the physical object may be obscured and thus, a viewer may not be optimally exposed to the advertisement(s).

### SUMMARY

It is to be understood that both the following general description and the following detailed description are exemplary and explanatory only and are not restrictive. Methods and systems for modifying content are described. A scene in content may have one or more objects suitable for advertisement placement. These objects may include, for example, a bus, a box, a building, a billboard, and/or the like. A computing device may identify one or more surfaces of objects (e.g., a side of the bus, a side of the box, a wall of the building, the billboard), and manipulate the scene and/or objects, and place an advertisement on one or more identified surfaces. Other configurations and examples are possible as well. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows an example system;

FIG. 2 shows a block diagram of an example device module;

FIG. 3 shows an example system;

FIGS. 4A-4F show example geometric renderings of example objects and surfaces;

FIGS. 5A-5F show example objects and surfaces in example video content;

FIG. 6 shows a flowchart of an example method;

FIG. 7 shows a flowchart of an example method;

FIG. 8 shows a flowchart of an example method; and

FIG. 9 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

“Content items,” as the phrase is used herein, may also be referred to as “content,” “content data,” “content information,” “content asset,” “multimedia asset data file,” or simply “data” or “information”. Content items may be any information or data that may be licensed to one or more individuals (or other entities, such as business or group). Content may be electronic representations of video, audio, text and/or graphics, which may be but is not limited to electronic representations of videos, movies, or other multimedia, which may be but is not limited to data files adhering to MPEG2, MPEG, MPEG4 UHD, HDR, 6 k, Adobe® Flash® Video (.FLV) format or some other video file format whether such format is presently known or developed in the future. The content items described herein may be electronic representations of music, spoken words, or other audio, which may be but is not limited to data files adhering to the MPEG-1 Audio Layer 5 (.MP3) format, Adobe®, CableLabs 1.0, 1.1, 5.0, AVC, HEVC, H.264, Nielsen watermarks, V-chip data and Secondary Audio Programs (SAP). Sound Document (.ASND) format or some other format configured to store electronic audio whether such format is presently known or developed in the future. In some cases, content may be data files adhering to the following formats: Portable Document Format (.PDF), Electronic Publication (.EPUB) format created by the International Digital Publishing Forum (IDPF), JPEG (.JPG) format, Portable Network Graphics (.PNG) format, dynamic advertisement insertion data (.csv), Adobe® Photoshop® (.PSD) format or some other format for electronically storing text, graphics and/or other information whether such format is presently known or developed in the future. Content items may be any combination of the above-described formats.

This detailed description may refer to a given entity performing some action. It should be understood that this language may in some cases mean that a system (e.g., a computer) owned and/or controlled by the given entity is actually performing the action.

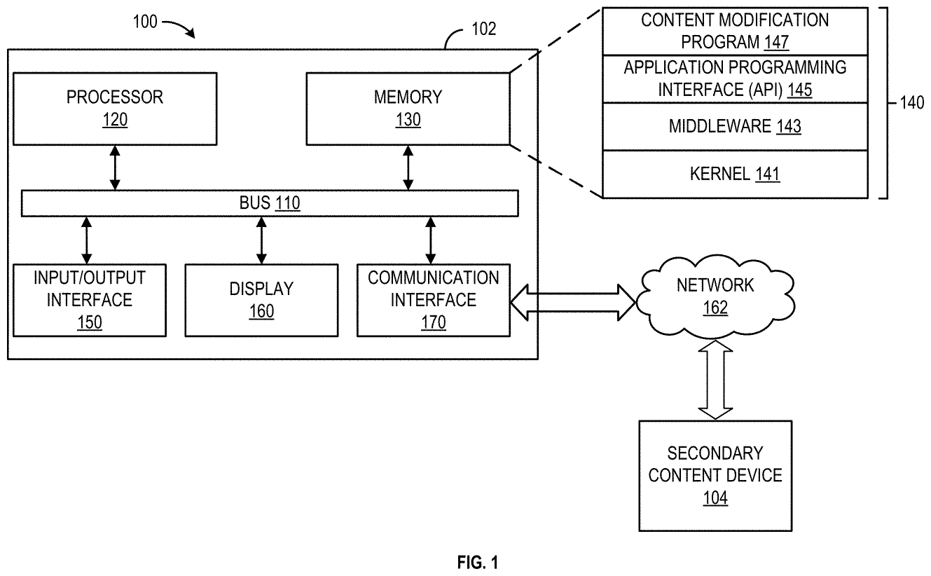

FIG. 1 shows an example system 100. The system 100 may comprise a computing device 102 configured for modifying content. The computing device 102 may include a bus 110, a processor 120, a memory 130, an input/output interface 150, a display 160, and a communication interface 170. The computing device 102 may be, for example, a server, a computer, a content source (e.g., a primary content source), a mobile phone, a tablet computer, a laptop, a desktop computer, a combination thereof, and/or the like. The computing device 102 may be configured to send, receive, store, generate, or otherwise process content, such as primary content and/or secondary content.

Primary content may comprise, for example, a movie, a television show, and/or any other suitable video content. For example, the primary content may comprise on-demand content, live content, streaming content, combinations thereof, and/or the like. The primary content may comprise one or more content segments, fragments, frames, etc. The primary content may comprise one or more scenes, and each may comprise at least one object. The at least one object may have a dimensionality (e.g., two or more dimensions) and thus may comprise at least one surface. The at least one surface may be defined by, for example, one or more coordinate pairs as described further herein. The at least one object and/or the at least one surface may be associated with (e.g., comprise) one or more output parameters. For example, the one or more output parameters may comprise or be associated with physical aspects of the at least one object and/or the at least one surface within the primary content. The physical aspects of the at least one object and/or the at least one surface within the primary content may be related to a position, an orientation, a length, a width, a height, a depth, an area, a volume, a flight path, motion, weight, mass, importance (e.g., interest), lighting, one or more rules, and/or the like.

The computing device 102 may be configured for graphics processing. For example, the computing device 102 may be configured to manipulate the primary content. The primary content may comprise computer generated imagery (CGI) data. The computing device 102 may be configured to send, receive, store, generate, or otherwise process the CGI data.

The one or more scenes may incorporate computer generated graphics. For example, a scene may comprise the at least one object (e.g., a CGI object). The one or more output parameters may be related to a position of the at least one object. For example, the one or more output parameters may comprise one or more coordinates (e.g., coordinate pairs or triplets) which define the at least one object within the primary content. The one or more output parameters may be related to/indicative of a flight path of the at least one object, and the flight path may comprise information related to how the one or more coordinates may be translated (e.g., changed/modified) as the at least one object moves within a scene of the primary content. The one or more output parameters may comprise one or more rules. The one or more rules may comprise, for example, physics rules as determined by a physics engine. For example, a rule of the one or more rules may dictate how acceleration due to gravity is depicted as acting on the at least one object in the at least one scene. For example, if the primary content comprises a movie taking place on the moon, the physics engine may dictate that the acceleration due to gravity is not 9.8 m/s², but rather is only 1.6 m/s², and thus, a falling object in a scene of that movie may behave differently than a falling object in a scene of a movie set on Earth. A second rule of the one or more rules may describe how wind resistance is to impact the flight path of the at least one object. Additional rules may define normal forces, elastic forces, frictional forces, thermodynamics, other physical and materials properties, combinations thereof, and/or the like. The aforementioned examples are merely exemplary and not intended to be limiting. The one or more rules may be any rules that define/determine how the one or more objects are depicted within the primary content.

The computing device 102 may be, or may be associated with, a content producer (e.g., film-making company, production company, post-production company, etc.). The computing device 102 may be configured with computer generated imagery capabilities (e.g., a CGI device). The computing device 102 may be configured for 3D modeling of full and/or partial CGI objects. The computing device 102 may be configured to supplement (e.g., with one or more 3D objects) recorded audio and/or video. The computing device 102 may be configured to supplement recorded audio and/or video by applying one or more image manipulation techniques that rely on 3D modeling of a real environment which may be based on position and/or viewing direction of one or more cameras. For example, during filming of content, video and/or audio may be recorded and synchronized with spatial locations of objects in the real world, as well as with a position and/or orientation of one or more cameras in space. Accordingly, 3D computer-generated and/or model-based objects (e.g., the at least one object described herein) may be inserted and/or modified in the primary content, for example during post-production.

The computing device 102 may be configured to process the primary content. The computing device 102 may be configured to determine a surface of interest associated with the at least one object. The surface of interest may be a surface with an area, visibility, time-on-screen, or other associated output parameter configured to expose the surface of interest to a viewing audience. The surface of interest may be a candidate for advertisement placement (e.g., a candidate surface).

The computing device 102 may manipulate any of the one or more output parameters so as to maximize exposure of the at least one surface to a viewer. For example, the computing device 102 may manipulate any of the one or more output parameters such that the manipulated output parameter(s) satisfies a threshold. For example, the computing device 102 may determine the at least one surface satisfies a surface area threshold. The surface area threshold may comprise a percentage of a screen covered by the at least one surface. The computing device 102 may determine the at least one surface satisfies a motion threshold. For example, the motion threshold may comprise a minimum or maximum speed at which the at least one object comprising the at least one surface moves, wherein a slow-moving object may be preferable to a fast-moving object.

The computing device 102 may insert secondary content onto the surface of interest. The computing device 102 may receive or otherwise determine available secondary content from a secondary content device 104. The secondary content may comprise, for example, one or more advertisements. The one or more advertisements may comprise, for example, an image, a logo, a product, a slogan, or some other product identifier/advertisement configured to be placed into a scene (e.g., product placement) of the primary content. The computing device 102 may be configured to manipulate the secondary content to fit onto the surface of interest. For example, the computing device 102 may be configured to resize, rotate, add/remove reflections, add/remove shadows, blur, sharpen, etc., the secondary content to fit onto the surface of interest of the primary content.

For example, the computing device 102 may determine (e.g., select) an item of secondary content from a plurality of items of secondary content that comports to the surface of interest. For example, the surface of interest may comprise a size, a ratio, a lighting parameter or any similar output parameter(s). The computing device 102 may select an advertisement suited for the size, ratio, lighting parameter, and/or the like. For example, a first item of secondary content may be a first size (e.g., a first surface area), and a second item of secondary content may be a second size (e.g., a second surface area). The computing device 102 may determine the surface of interest is configured to accommodate the first item of secondary content because they have similar sizes while the surface of interest is not configured to accommodate the second item of secondary content because they are not the same size. Similarly, if the surface of interest is surrounded by dark coloring, the computing device 102 may insert a light colored piece of secondary content onto the surface of interest so as to create optimal contrast.

The computing device 102 may be configured to determine the secondary content based on content data such as a title, genre, target audience, combinations thereof, and the like. The computing device 102 may be configured to determine, for example, via object recognition, appropriate advertisements based on context. The context may be defined by a type, category, etc. associated with the at least one object and/or the surface of interest. For example, the computing device 102 may determine that the surface of interest is part of a wine bottle (as opposed to a 2 liter soda bottle) and thus may select secondary content associated with a brand of wine, rather than a brand of soda.

In an embodiment, the surface of interest may be covered with a solid image (e.g., a “green screen” image) to facilitate insertion of secondary content onto the surface of interest by, for example, the secondary content device 104. In an embodiment, the computing device 102 may determine the coordinates associated with a value indicating the surface of interest is a candidate for advertisement placement as it has a particular size, has a given on-screen-time, satisfies a motion parameter, or the like as further described herein. The computing device 102 may be configured to designate the surface of interest if an output parameter (or a changed/modified output parameter) satisfies a threshold. For example, the primary content surface 102 may assign a value to coordinates that define the surface of interest. For example, a value of “1” may indicate the surface of interest is designated for advertisement placement and a value of “0” may indicate the surface of interest is not designated for advertisement placement.

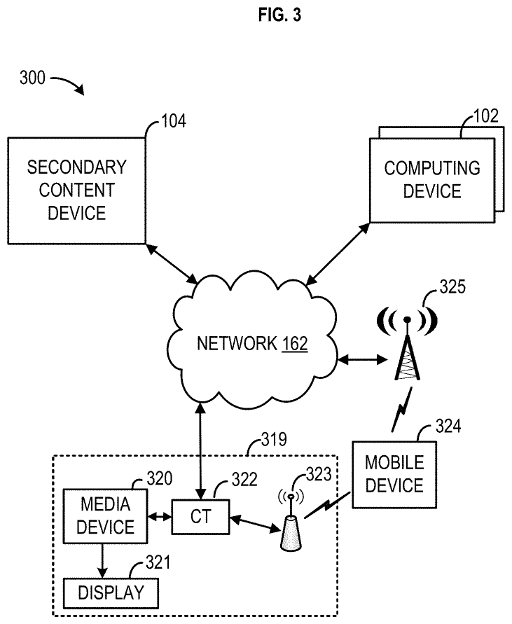

The computing device 102 may be configured to send, receive, store, process, and/or otherwise provide the primary content (e.g., video, audio, games, movies, television, applications, data) to any of the devices in the system 100 and/or a system 300 (as described in further detail below). The primary content device 102 may be configured to send the primary content to the secondary content device 104 as described in further detail herein with reference FIG. 3. The secondary content device 104 may be configured to insert the secondary content into the primary content.

The bus 110 may include a circuit for connecting the aforementioned constitutional elements 120 to 170 to each other and for delivering communication (e.g., a control message and/or data) between the aforementioned constitutional elements. The processor 120 may include one or more of a Central Processing Unit (CPU), an Application Processor (AP), and a Communication Processor (CP). The processor 120 may control, for example, at least one of other constitutional elements of the computing device 102 and/or may execute an arithmetic operation or data processing for communication.

The memory 130 may include a volatile and/or non-volatile memory. The memory 130 may store, for example, a command or data related to at least one different constitutional element of the computing device 102. The memory 130 may store a software and/or a program 140. The program 140 may include, for example, a kernel 141, a middleware 143, an Application Programming Interface (API) 145, and/or a content modification program 147, or the like. The content modification program 147 may configured for manipulating primary content. For example, the content modification program 147 may be configured to manipulate the one or more output parameters.

At least one part of the kernel 141, middleware 143, or API 145 may be referred to as an Operating System (OS). The memory 130 may include a computer-readable recording medium having a program recorded therein to perform the methods.

The kernel 141 may control or manage, for example, system resources (e.g., the bus 110, the processor 120, the memory 130, etc.) used to execute an operation or function implemented in other programs (e.g., the middleware 143, the API 145, or the application program 147). Further, the kernel 141 may provide an interface capable of controlling or managing the system resources by accessing individual constitutional elements of the computing device 102 in the middleware 143, the API 145, or the content modification application program 147.

The middleware 143 may perform, for example, a mediation role so that the API 145 or the content modification program 147 may communicate with the kernel 141 to exchange data. Further, the middleware 143 may handle one or more task requests received from the content modification program 147 according to a priority. For example, the middleware 143 may assign a priority of using the system resources (e.g., the bus 110, the processor 120, or the memory 130) of the computing device 102 to the content modification program 147. For instance, the middleware 143 may process the one or more task requests according to the priority assigned to the content modification program 147, and thus may perform scheduling or load balancing on the one or more task requests.

The API 145 may include at least one interface or function (e.g., instruction), for example, for file control, window control, video processing, or character control, as an interface capable of controlling a function provided by the content modification program 147 in the kernel 141 or the middleware 143. For example, the input/output interface 150 may play a role of an interface for delivering an instruction or data input from a user or a different external device(s) to the different constitutional elements of the computing device 102. Further, the input/output interface 150 may output an instruction or data received from the different constitutional element(s) of the computing device 102 to the different external device.

The display 160 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 160 may display, for example, a variety of contents (e.g., text, image, video, icon, symbol, etc.) to the user. The display 160 may include a touch screen. For example, the display 160 may receive a touch, gesture, proximity, or hovering input by using a stylus pen or a part of a user's body.

The communication interface 170 may establish, for example, communication between the computing device 102 and an external device (e.g., the secondary content device 104) For example, the communication interface 170 may communicate with the secondary content device 104 by being connected to a network 162. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. Further, the wireless communication may include, for example, a near-distance communication. The near-distance communication may include, for example, at least one of Wireless Fidelity (WiFi), Bluetooth, Near Field Communication (NFC), The network 162 may include, for example, at least one of a telecommunications network, a computer network (e.g., LAN or WAN), the internet, and/or a telephone network.

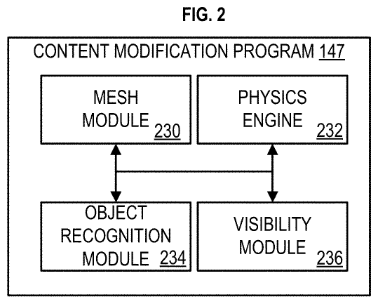

FIG. 2 shows the content modification program 147. The content modification program 147 may comprise a mesh module 230, a physics engine 232, an object recognition module 234, and a visibility module 236. The mesh module 230 may be configured to send, receive, store, generate, and/or otherwise process mesh data. Mesh data may comprise data related to the one or more coordinates which define the at least one object described herein. Mesh data may comprise weighting data. For example, weighting data may describe mass associated with various sections (e.g., vertices, edges, surfaces, combinations thereof, and the like) of the at least one object. For example, weighting data may be associated with a center of mass of the at least one object and thus weighting data may impact how the one or more rules impact a motion (e.g., a flight path) of the at least one object. Mesh data may comprise surface of interest data. For example, during production of the primary content, a surface of interest associated with the at least one object may be determined. The surface of interest may be a surface that is a candidate for insertion of secondary content (e.g., a candidate for advertisement placement). For example, the surface of interest may be a surface with a large area, a surface that remains visible to a viewer during a scene for an amount of time, a surface that may be modified or adjusted to remain visible to a viewer during a scene for an amount of time, a surface which is well lit or highly contrasted with an area of the screen surrounding the surface, etc.

The object recognition module 234 may be configured to perform object detection and/or object recognition in order to determine one or more objects which may comprise one or more surfaces that are candidates for advertisement placement. The object recognition module 234 may be configured to perform object detection and/or object recognition in order to determine one or more objects which may comprise one or more surfaces that are candidates for advertisement placement. For example, the object recognition module 234 may determine a scene of the primary content comprises a CGI wine bottle and thus a surface of the wine bottle is a candidate for advertisement placement. The object recognition module 234 may designate that surface of advertisement placement. For example, the object recognition module 234 may be configured to identify one or more consumer goods, one or more billboard style structures, walls, windows, etc. in the at least one scene and designate those surfaces for advertisement placement.

The physics engine 232 may send, receive, store, generate, and/or otherwise process the primary content according to the one or more rules. The physics engine 232 may comprise computer software configured to determine an approximate simulation of one or more physical systems, such as rigid body dynamics (including collision detection), soft body dynamics, fluid dynamics, mechanics, thermodynamics, electrodynamics, other physical phenomena and properties, combinations thereof, and the like. For example, the physics engine 232 may determine that, in a given scene, an explosion causes a first force to act on the at least one object causing the at least one object to accelerate into the air. The physics engine 232 may determine a first flight path associated with the at least one object. The at least one object may comprise the surface of interest. The physics engine 232 may determine that, without intervention or manipulation, upon landing, the surface of interest may not be visible. The physics engine 232 may therefore adjust an output parameter (e.g., the first flight path) associated with the at least one object to result in the object landing with the at least one surface visible to the viewer. For example, the physics engine 232 may determine a first plurality of coordinates that define the surface of interest and a second plurality of coordinate that define a remainder of the at least one object. A motion associated with the at least one object may be defined by one or more translations of the first plurality of coordinates and the second plurality of coordinates. The physics engine 232 may manipulate the translations of either or both of the first plurality of coordinates and the second plurality of coordinates, and thereby adjust the flight path to ensure the at least one object lands with the surface of interest visible to a viewer. Similarly, the physics engine 232 may be configured to adjust a speed (e.g., velocity, acceleration) associated with the at least one object. For example, the physics engine 232 may be configured to “slow down” the at least one object so as to increase the amount of time the at least one surface is visible to the viewer. The physics engine 232 may determine that an output parameter of the one or more output parameters satisfies a threshold (a speed threshold, motion threshold, etc.) and may designate the associated surface for advertisement placement.

The visibility module 236 may be configured to send, receive, store, generate, and/or otherwise process the primary content. For example, the visibility module 236 may be configured to determine the one or more output parameters associated with the at least one surface. For example, the visibility module 236 may be configured to process the primary content to determine a surface area associated with the at least one surface, a lighting condition associated with the at least one surface, timing data associated with the at least one surface (e.g., a length of time during which the surface is visible), a clarity parameter associated with the at least one surface (e.g., how blurry the surface is), a contrast parameter, combinations thereof, and the like. For example, the visibility module 236 may be configured to determine a visibility parameter associated with the surface of interest. For example, the visibility parameter may indicate, in a relative or absolute sense, how visible the surface of interest is to a viewer. For example, the visibility parameter may indicate a percentage of screen area occupied by the surface of interest, a percentage of time (e.g., as compared to the total length of a scene, content segment, combinations thereof, and the like) during which the surface of interest is visible to a viewer, a contrast between the surface of interest and a surrounding area on a screen, a motion of the surface of interest (e.g., slow-moving vs. rapidly moving), combinations thereof, and the like. The visibility module 236 may be configured to adjust an output parameter so as to, for example, increase the visibility parameter associated with the surface of interest. For example, the visibility module 236 may manipulate the first plurality of coordinates and/or the second plurality of coordinates so as to increase the surface area of the surface of interest. For example, the visibility module 236 may change the at least one output parameter of the one or more output parameters associated with the scene so as to make the area around the surface of interest brighter and/or the remainder of the scene darker. For example, the visibility module 236 may be configured to increase the clarity (e.g., definition, contrast, etc.) of the area around the surface of interest and/or blur out the rest of the scene (or some portion thereof). It is to be understood that the above mentioned examples are purely exemplary and explanatory and are not limiting. The visibility module 236 may determine an output parameter of the one or more output parameters satisfies a threshold (a lighting threshold, contrast threshold, visibility threshold, or the like) and may designate the associated surface for advertisement placement.

FIG. 3 shows an example system 300 for content modification. The system 300 may comprise the computing device 102, the secondary content device 104, a network 162, a media device 320, and a mobile device 324. Each of the computing device 102, the secondary content device 104, and/or the media device 320 may be one or more computing devices, and some or all of the functions performed by these components may at times be performed by a single computing device.

The computing device 102, the secondary content device 104, and/or the media device 320 may be configured to communicate through the network 162. The network 162 may facilitate sending data, signals, content, combinations thereof and the like, to/from and between the computing device 102, and the secondary content device 104. For example, the network 162 may facilitate sending one or more primary content segments from the computing device 102, and/or one or more secondary content segments from the secondary content device 104 to, for example, the media device 320 and/or the mobile device 324. The network 162 may be a content delivery network, a content access network, combinations thereof, and the like. The network may be managed (e.g., deployed, serviced) by a content provider, a service provider, combinations thereof, and the like. The network 162 may be an optical fiber network, a coaxial cable network, a hybrid fiber-coaxial network, a wireless network, a satellite system, a direct broadcast system, or any combination thereof. The network 162 may be the Internet.

The computing device 102 may be configured to provide (e.g., send) the primary content via a packet switched network path, such as via an Internet Protocol (IP) based connection. The primary content may be accessed by users via applications, such as mobile applications, television applications, set-top box applications, gaming device applications, and/or the like. An application may be a custom application (e.g., by content provider, for a specific device), a general content browser (e.g., web browser), an electronic program guide, and/or the like. The computing device 102 may be configured to send the primary content to one or more devices such as the secondary content device 104, the network component 329, a first access point 323, the mobile device 324, a second access point 325, and/or the media device 320. The computing device 102 may be configured to send the primary content via a packet switched network path, such as via an IP based connection.

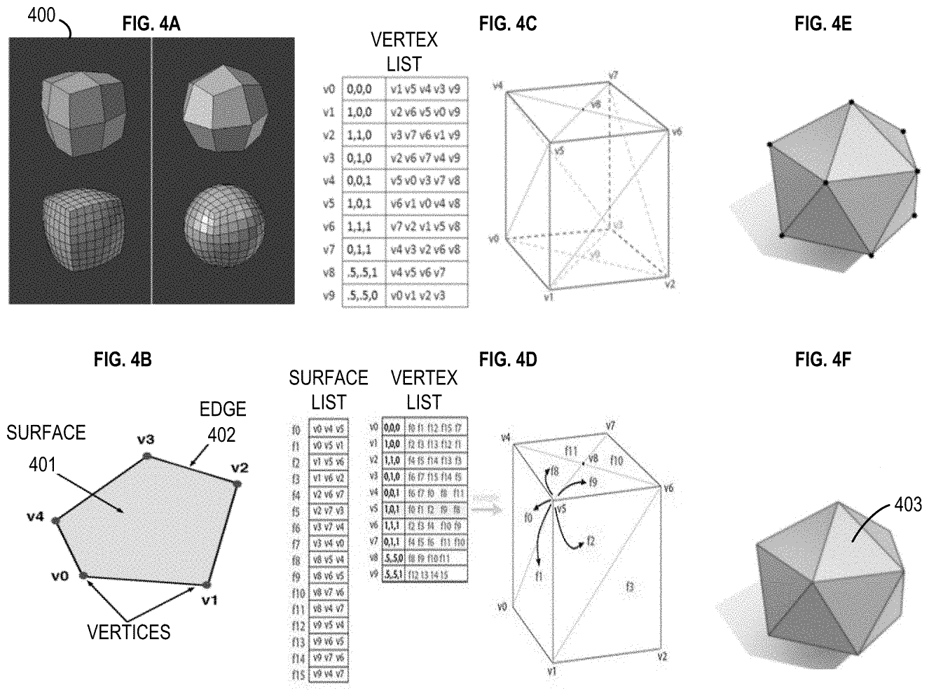

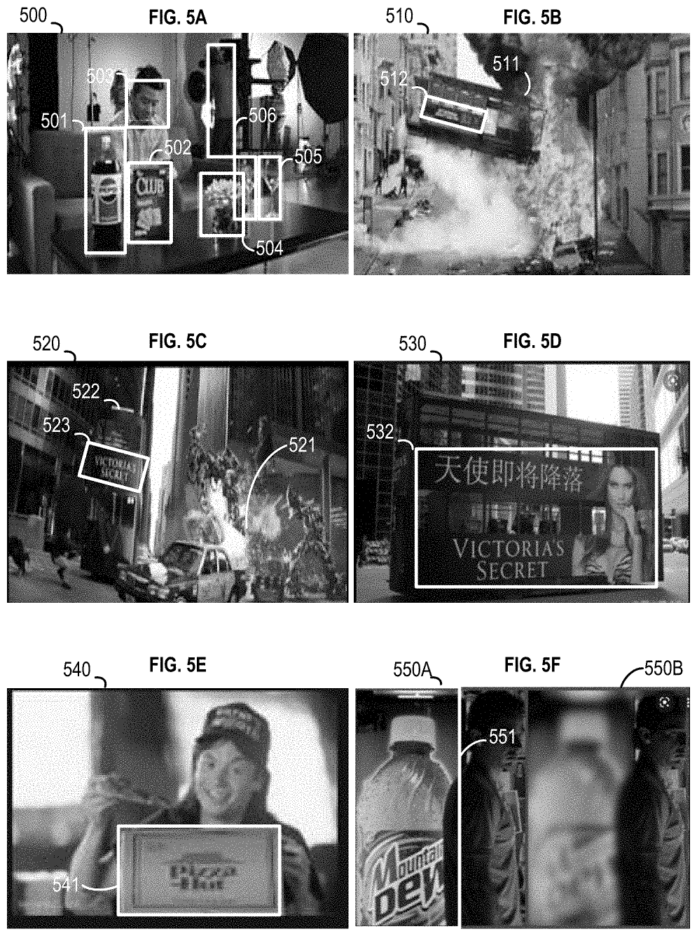

The secondary content device 104 may be configured to receive the primary content. For example, the secondary content device 104 may receive the primary content from the computing device 102. The secondary content device 104 may determine the surface of interest. For example, the secondary content device 104 may determine the coordinates associated with a value indicating the surface is designated for advertisement placement because it has a surface of a particular size, has a given on-screen-time, satisfies a motion parameter, or the like as further described herein. Based on determining the surface, the secondary content device 104 may determine secondary content. Similarly, the secondary content device 104 may determine a “green screen” image configured to facilitate insertion of secondary content onto the at least one surface. The secondary content may comprise, for example, one or more advertisements. The one or more advertisements may comprise, for example, an image, product, or some other advertisement configured to be placed into a scene (e.g., product placement). Examples of product placements are given below with reference to FIGS. 4A-4F and 5A-5F.

The secondary content device 104 may be configured to determine, based on the one or more output parameters associated with the surface of interest, at least one advertisement of the one or more advertisements. For example, the secondary content device 104 may determine an item of secondary content from a plurality of items of secondary content that comports to the surface of interest. For example, the surface of interest may comprise a size, ratio, lighting parameter or similar output parameter and the secondary content device 104 may select an advertisement suited for the size, ratio, lighting parameter, or the like. For example, a first item of secondary content may be a first size (e.g., a first surface area) and a second item of secondary content may be a second size (e.g., a second surface area). The secondary content device 104 may determine the surface of interest is configured to accommodate the first item of secondary content because they have similar sizes while the surface of interest is not configured to accommodate the second item of secondary content because they are not the same size. Similarly, if the surface of interest is surrounded by dark coloring, the secondary content device 104 may insert a light colored piece of secondary content onto the surface of interest so as to create optimal contrast.

The secondary content device 104 may be configured to determine the secondary content based on content data such as a title, genre, target audience, combinations thereof, and the like. The secondary content device 104 may be configured to determine, for example, via object recognition, appropriate advertisements. For example, the secondary content device 104 may determine that the surface of interest is part of a wine bottle (as opposed to a 2 liter soda bottle) and thus may select secondary content associated with a brand of wine, rather than a brand of soda.

The network 162 may distribute signals from any of computing device 102, the secondary content device 104, or any other device of FIG. 1 or FIG. 3 to user locations, such as a premises 319. The premises 319 may be associated with one or more viewers. For example, the premises 319 may be a viewer's home. A user account may be associated with the premises 319. The signals may be one or more streams of content, such as the primary content and/or the secondary content described herein.

A multitude of users may be connected to the network 162 at the premises 319. At the premises 319, the media device 320 may demodulate and/or decode (e.g., determine one or more audio frames and video frames), if needed, the signals for display on a display device 321, such as on a television set (TV) or a computer monitor. The media device 320 may be a demodulator, decoder, frequency tuner, and/or the like. The media device 320 may be directly connected to the network (e.g., for communications via in-band and/or out-of-band signals of a content delivery network) and/or connected to the network 162 via a communication terminal 322 (e.g., for communications via a packet switched network). The media device 320 may be a set-top box, a digital streaming device, a gaming device, a media storage device, a digital recording device, a combination thereof, and/or the like. The media device 320 may comprise one or more applications, such as content viewers, social media applications, news applications, gaming applications, content stores, electronic program guides, and/or the like. The signal may be demodulated and/or decoded in a variety of equipment, including the communication terminal 322, a computer, a TV, a monitor, or a satellite dish.

The media device 320 may receive the primary content and/or the secondary content described herein. The media device 320 may cause output of the primary content and/or the secondary content described herein. The primary content and/or the secondary content may be displayed via the display device 321. The media device 320 may cause output of an advertisement, such as the secondary content described herein.

The communication terminal 322 may be located at the premises 319. The communication terminal 322 may be configured to communicate with the network 162. The communication terminal 322 may be a modem (e.g., cable modem), a router, a gateway, a switch, a network terminal (e.g., optical network unit), and/or the like. The communication terminal 322 may be configured for communication with the network 162 via a variety of protocols, such as internet protocol, transmission control protocol, file transfer protocol, session initiation protocol, voice over internet protocol, and/or the like. For a cable network, the communication terminal 322 may be configured to provide network access via a variety of communication protocols and standards, such as Data Over Cable Service Interface Specification (DOC SIS).

The premises 319 may comprise a first access point 323, such as a wireless access point. The first access point 323 may be configured to provide one or more wireless networks in at least a portion of the premises 319. The first access point 323 may be configured to provide access to the network 162 to devices configured with a compatible wireless radio, such as a mobile device 324, the media device 320, the display device 321, or other computing devices (e.g., laptops, sensor devices, security devices). The first access point 323 may provide a user managed network (e.g., local area network), a service provider managed network (e.g., public network for users of the service provider), and/or the like. It should be noted that in some configurations, some or all of the first access point 323, the communication terminal 322, the media device 320, and the display device 321 may be implemented as a single device.

The premises 319 may not be fixed. A user may receive content from the network 162 on the mobile device 324. The mobile device 324 may be a laptop computer, a tablet device, a computer station, a personal data assistant (PDA), a smart device (e.g., smart phone, smart apparel, smart watch, smart glasses), GPS, a vehicle entertainment system, a portable media player, a combination thereof, and/or the like. The mobile device 324 may communicate with a variety of access points (e.g., at different times and locations or simultaneously if within range of multiple access points). The mobile device 324 may communicate with a second access point 325. The second access point 325 may be a cell tower, a wireless hotspot, another mobile device, and/or other remote access point. The second access point 325 may be within range of the premises 319 or remote from premises 319. The second access point 325 may be located along a travel route, within a business or residence, or other useful locations (e.g., travel stop, city center, park).

The second access point 325 may be configured to provide content, services, and/or the like to the premises 319. The second access point 325 may be one of a plurality of edge devices distributed across the network 162. The second access point 325 may be located in a region proximate to the premises 319. A request for content from the user may be directed to the second access point 325 (e.g., due to the location of the AP/cell tower and/or network conditions). The second access point 325 may be configured to package content for delivery to the user (e.g., in a specific format requested by a user device), provide the user a manifest file (e.g., or other index file describing portions of the content), provide streaming content (e.g., unicast, multicast), provide a file transfer, and/or the like. The second access point 325 may cache or otherwise store content (e.g., frequently requested content) to enable faster delivery of content to users.

FIGS. 4A-4F show example diagrams. FIG. 4A shows a plurality of objects. Each object of the plurality of objects may be represented as a mesh. The mesh may comprise a polygon mesh. The mesh may comprise one or more vertices, edges, and faces which may define a polyhedral object (e.g., the at least one object). The faces may comprise the at least one surface. The faces may comprise triangles, quadrilaterals, or other polygons (e.g., convex polygons, n-gons). The polygons may be configured for various applications such as Boolean logic (e.g., constructive solid geometry), smoothing, simplification, ray tracing, collision detection, rigid-body dynamics, wireframe modeling, combinations thereof, and the like. The meshes may comprise vertex-vertex meshes, face-vertex meshes, winged-edge meshes, or other meshes. A mesh may comprise one or more surfaces. A surface of the one or more surfaces (e.g., the surface) may comprise an outermost boundary (or one of the boundaries) of any body, immediately adjacent to air or empty space, or to another body.

As seen in FIG. 4A, each object of the plurality of objects may comprise one or more surfaces (e.g., one or more faces). For example, each object of the one or more objects may be defined as one or more surfaces, wherein each surface of the one or more surfaces is defined as one or more vertices connected by one or more edges. The output parameters associated with an object of the one or more objects may comprise, for example, a surface area as defined by the one or more vertices and/or one or more edges. The one or more output parameters may also comprise, for example, a lighting parameter (e.g., how dark or like the surface is). The computing device 102 may be configured to adjust an output parameter of the one or more output parameters. For example, the computing device 102 may adjust the surface area as described herein and/or may adjust the lighting parameter by, for example, making the surface lighter or darker so as to increase or decrease a contrast with a nearby surface.

FIG. 4B shows a detailed view of a surface 401 defined by vertices v0, v1, v2, v3, and v4 and corresponding edges (e.g., edge 402 and others). Each vertex of the one or more vertices may be defined by one or more coordinates. FIG. 4C shows an example vertex list and corresponding object. The computing device 102 may determine a vertex list associated with the at least one object and may determine, based on the vertex list, the at least one surface (e.g., as defined by one or more vertices on the vertex list. The vertex list may comprise one or more vertexes wherein each vertex is defined by one or more coordinates (e.g., a coordinate pair and/or a coordinate triplets). The one or more coordinates may be Cartesian coordinates, Euclidean coordinates, polar coordinates, spherical coordinates, cylindrical coordinates, or any other coordinate system.

For example, v0 is defined as being located at coordinates 0, 0, 0 while v1 is located at 1, 0, 0, and v6 is located at 1, 1, 1. The vertex list may comprise data indicating one or more associations between the one or more vertices. For example, the vertex list indicates v0 is connected (e.g., via one or more edges) with vertices v1, v5, v4, v3, and v9. The computing device 102 may be configured to perform a translation of the one or more coordinates so as to adjust the one or more output parameters. For example, the computing device 102 may translate one or more coordinates to present a give surface to a viewer. For example, the computing device 102 may translate the one or more coordinates (or adjust the translation thereof over a temporal domain) so as to manipulate a flight path of an object comprising the one or more coordinates. The computing device 102 may be configured to manipulate one or more of the one or more coordinates so as to, for example, increase the surface area of a surface.

FIG. 4D shows an example surface list comprising one or more surfaces. The one or more surfaces may also be referred to as faces. The surface list may comprise information related to the one or more surfaces such as indications of the one or more vertices that define a surface of the one or more surfaces. For example, surface f0 is defined as being the surface defined by vertices v0, v4, and v5. The vertex list in FIG. 4D contains indications of the one or more surfaces which may be partially defined by a vertex. For example, vertex v0 is a vertex which partially defines surfaces f0, f1, ff12, f15, and f17. The computing device 102 may be configured to designate a surface for advertisement insertion. FIGS. 4E and 4F show an object as defined by vertices and edges wherein surface 403 has been identified as a surface of interest.

FIGS. 5A-5F show example objects and surfaces in example video content. For example, FIG. 5A shows an example scene 500. Within the example scene 500, the computing device 102 may have identified, via the object detection module 234, one or more objects in the scene 500. For example, the scene 500 may include a bottle of soda 501, a box of crackers 502, a first person 503, a flower vase 504, champagne flutes 505, and a second person 506. For example, the computing device 102 may be configured to determine that flatter, more uniform surfaces, such as those associated with objects 501 and 502 (e.g., the soda bottle and the box of crackers) are candidates for inserting the secondary content described herein. As such, either of the computing device 102 or the secondary content device 104 may place, on the surfaces associated with the objects 501 and 502, advertisements (e.g., a PEPSI advertisement and a CLUB CRACKERS advertisement, respectively. The computing device 102 may be configured to determine one or more flat services by analyzing data associated with the primary content such as indicated vertices, surfaces, and the like, as described with respect to FIGS. 5A-5F. Additionally, and/or alternatively, the computing device 102 may be configured for object detection and recognition. For example, object detection and recognition may be comprise determining contours associated with a surface and analyzing color and/or greyscale gradients. Additionally and/or alternatively, the computing device 102 may be configured to, for example via the object recognition module, determine that the first person 503 and the second person 506 are, in fact, people. Further, the computing device 102 may determine the irregular shapes and surfaces associated with human faces are not candidates for placement of secondary content.

FIG. 5B shows an example scene 510. In example scene 510 an explosion has taken place. The explosion caused the trolley 511 to accelerate into the air. The computing device 102 may determine the trolley 511 contains a surface of interest 512. The computing device 102, may be configured to, for example via the physics engine 232, determine a flight path parameter associated with the trolley. The computing device 102 may manipulate the flight path of the trolley 511 such that the surface of interest 512 faces a viewer (e.g., the camera recording the scene) rather than spinning. For example, in the context of traditional television content (e.g., content displayed on a traditional television with a “flat screen” on which images are displayed), whether created via CGI or traditional image capture technologies, the physics engine 232 may manipulate the projected flight path of the trolley 511 such that surface 512 faces the camera (e.g., the point of view of the viewer) that captures the scene. In an embodiment featuring augmented reality and/or virtual reality (AR/VR) and or holographic technology, one or more gaze sensors may be employed to determine a gaze of a viewer. For example, an AR/VR headset may comprise one or more cameras or other sensors configured to determine the gaze of the viewer. For example, the one or more cameras or other sensors may be directed towards the face (e.g., the eyes) of the viewer. Furthermore, the one or more other sensors may comprise one or more gyroscopes, accelerometers, magnetometers, GPS sensors, or other sensors configured to determine a direction of the viewers gaze (e.g., not only where the viewer's eyes are pointed, but also the direction that the viewer's head is pointed).For example, in an AR implementation, while the viewer rotates his or her head, and thus, the background of a scene may change (according to the physical, non-augmented space occupied by the viewer), the physics engine 232 may manipulate the projected flight path of the trolley 511 such that the trolley 511 remains in the view of the viewer.

FIG. 5C shows an example scene 520. The example scene 520 includes an explosion 521 taking place on a street. A bus 522 is travelling towards the viewer and on the front of the bus is an advertisement for VICTORIA'S SECRET. The computing 102 may determine a native advertisement 523 occupies only a small percentage of the screen and therefore, may manipulate a motion path parameter (e.g., a trajectory) of the bus to spin so a larger surface (e.g., a side of the bus with greater surface area) is shown after the explosion and thus a larger advertisement 532 may be presented (as shown in scene 530 in FIG. 5D).

FIG. 5E shows an example scene 540. In example scene 540, the computing device 102 has identified surface of interest 541 as a candidate for placing secondary content and thus has inserted a PIZZA HUT logo. Meanwhile, the computing device 102 may increase a clarity output parameter associated with the surface of interest 541 while decreasing a clarity output parameter associated with the background of the scene. Similarly, FIG. 5F shows examples scenes 550A and 550B. In scene 550B, which may represent an unedited or as-produced scene, only the actor in the foreground is associated with a high clarity parameter while the background containing the surface of interest 551 is associated with a low clarity parameter. Thus, in scene 550A, the computing device 102 has increased the clarity parameter of the surface 551 so as bring the viewer's attention to the MOUNTAIN DEW advertisement.

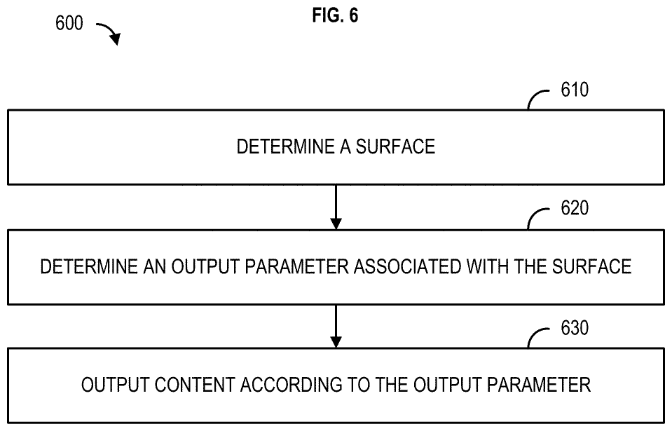

FIG. 6 shows a flowchart of a method 600 for content modification. The method may be carried out by any of, or any combination of, the devices describe herein such as, for example, the computing device 102 and/or, the secondary content device 104.

At step 610, at least one surface in content may be determined. For example, a computing device may receive primary content (e.g., from a primary content source). The primary content may comprise one or more content segments. The primary content may comprise a single content item, a portion of a content item (e.g., content fragment), a content stream, a multiplex that includes several content items, combinations thereof, and the like. The primary content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The primary content may comprise live-action content, animated content, digital content, and/or the like. The primary content may comprise one or more scenes. At least one scene of the one or more scenes may incorporate computer generated graphics (CGI). The primary content may comprise and/or otherwise be associated with one or more output parameters. The one or more output parameters may comprise information related to position, orientation, length, width, height, depth, area, volume, flight path, motion, weight, mass, importance (e.g., interest), lighting, one or more rules, and/or the like. For example, information related to position may comprise one or more coordinates (e.g., coordinates pairs or triplets) which define the at least one object.

The computing device may determine a surface of interest in the primary content. The surface of interest may be a surface that is a candidate for insertion of secondary content. For example, the surface of interest may be a surface with a large area, a surface that remains visible to a viewer during a scene for an amount of time, a surface which is well lit, etc.

At step 620, the computing device may determine at least one output parameter of the one or more output parameters associated with the surface. The at least one output parameter, may comprise, for example, a position, an orientation, a length, a width, a height, a depth, an area, a volume, a flight path, a motion, a weighting value, a mass parameter, or a lighting parameter associated with the at least one surface.

At step 630, the computing device may output the content. For example, the computing device may send the content to downstream device such as the secondary content device, a user device such as a media device, a distribution device, or any other device. The content may comprise an adjusted at least one output parameter. The adjusted at least one output parameter may be associated with the at least one surface. For example the adjusted at least one output parameter may comprise an adjusted surface area, and adjusted lighting parameter, an adjusted flight path, or any other output parameter as described herein.

The method may further comprise adjusting the at least one output parameter. For example, the computing device may adjust the at least one output parameter so as to maximize exposure of the at least one surface during output of the content. Adjusting the output parameter may comprise adjusting at least one of: a position, an orientation, a length, a width, a height, a depth, an area, a volume, a flight path, a motion, a weighting value, a mass parameter, an importance parameter, or a lighting parameter. For example, information related to position may comprise one or more coordinates (e.g., coordinates pairs or triplets) which define the at least one object. For example, information related to flight path may comprise information related to how the one or more coordinates which define the object may be translated as the at least one object moves within a scene. The rules may comprise, for example, physics rules as determined by a physics engine. For example, a rule of the one or more rules may dictate how acceleration due to graphic is depicted in the at least one scene. For example, if the primary content comprises a movie taking place on the moon, the physics engine may dictate that the acceleration due to gravity is not 9.8 m/s², but rather is only 1.6 m/s², and thus, a falling object in a scene of that movie may behave differently than a falling object in a scene of a movie set on Earth. For example, the computing device may manipulate the first plurality of coordinates so as to increase the surface area of the surface of interest. For example, the computing device may change at least one output parameter associated with the scene so as to make the area around the surface of interest brighter and/or the remainder of the scene darker. For example, the computing device may be configured to increase the clarity (e.g., definition, contrast, etc. . . . ) of the area around the surface of interest and/or blur out the rest of the scene (or some portion thereof). A person skilled in the art will appreciate that the above mentioned examples are purely exemplary and explanatory and are not limiting.

The method may further comprise determining secondary content suitable for placement on the at least one surface. For example, determining the secondary content suitable for placement on the at least one surface may be based on surface data such as area, length, width, height, or any output parameter of the one or more output parameters. The method may further comprise inserting, into the primary content, the secondary content.

The method may further comprise based on the at least one surface being a candidate for placement of secondary content, determining at least one output parameter associated with the at least one object and adjusting the at least one output parameter associated with at least one object to maximize exposure of the at least one surface during output of the content.

The primary content may comprise at least one scene, and the method may further comprise based on the at least one surface being a candidate for placement of secondary content, determining at least one output parameter associated with the at least one scene and adjusting the at least one output parameter associated with the at least one scene to maximize exposure of the at least one surface during output of the at least one scene.

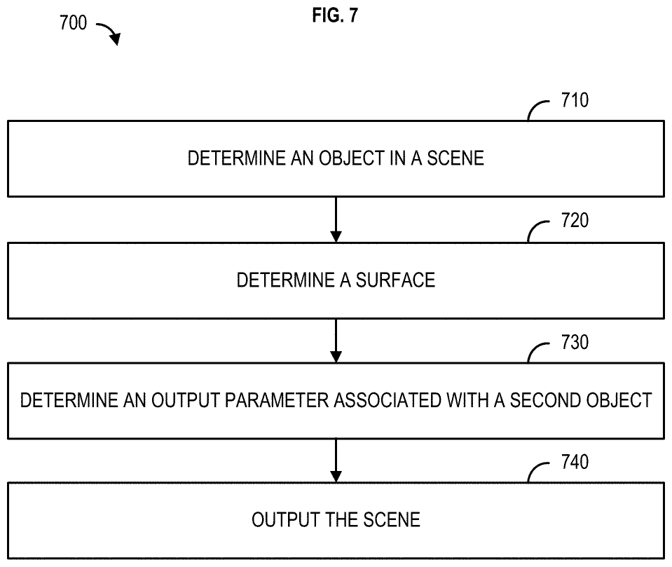

FIG. 7 shows a flowchart of a method 700 for content modification. The method may be carried out by any of, or any combination of, the devices describe herein such as, for example, the computing device 102 and/or, the secondary content device 104.

At step 710, a computing device may determine at least one first object from a plurality of objects in a scene. For example, the computing device may receive primary content (e.g., from a primary content source). The primary content may comprise one or more content segments. The primary content may comprise a single content item, a portion of a content item (e.g., content fragment), a content stream, a multiplex that includes several content items, combinations thereof, and the like. The primary content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The primary content may comprise live-action content, animated content, digital content, and/or the like. The primary content may comprise one or more scenes. At least one scene of the one or more scenes may incorporate computer generated graphics (CGI). The primary content may comprise and/or otherwise be associated with output parameters. The one or more output parameters may comprise information related to position, orientation, length, width, height, depth, area, volume, flight path, motion, weight, mass, importance (e.g., interest), lighting, one or more rules, and/or the like. For example, information related to position may comprise one or more coordinates (e.g., coordinates pairs or triplets) which define the at least one object. The at least one scene of the one or more scenes may comprise the plurality of objects.

At step 720, the computing device may determine that the at least one surface is a candidate for placement of secondary content. The secondary content may comprise the secondary content. For example, the secondary content may comprise one or more advertisements. The computing device, via, for example, object detection and/or object recognition, may determine an object of interest in the scene. For example, the object of interest may comprise a surface of interest. The surface of interest may be a surface that is a candidate for insertion of secondary content. For example, the surface of interest may be a surface with a large area, a surface that remains visible to a viewer during a scene for an amount of time, a surface which is well lit, etc.

At step 730, the computing device may determine at least one output parameter of the one or more output parameters associated with a second object. For example, the at least one output parameter, may comprise a position, an orientation, a length, a width, a height, a depth, an area, a volume, a flight path, a motion, a weighting value, a mass parameter, an importance parameter, or a lighting parameter associated with the at least one second object.

At step 740, the computing device may cause the scene to be output. For example, the computing device may send the scene to a downstream device such as secondary content device, a user device such as a media device, a distribution device, or any other device. For example, the computing device may cause the scene to be displayed on a downstream device such as a user device. The scene may comprise an adjusted at least one output parameter. The adjusted at least one output parameter may be associated with the at least one surface. For example the adjusted at least one output parameter may comprise an adjusted surface area, and adjusted lighting parameter, an adjusted flight path, or any other output parameter as described herein. For example, the computing device may adjust the at least one output parameter associated with the at least one second object so as to maximize exposure of the at least one surface (e.g., the at least one first object). For example, the computing device may determine a position of the at least one second object intersects a flight path of the at least one first object comprising the at least one surface. The computing device may alter the position of the at least one second object so it no longer intersects (e.g., no longer “blocks”) the flight path the at least one first object.

The method may further comprise adjusting the at least one output parameter. For example, adjusting the at least one output parameter associated with the at least one surface may comprise changing at least one of: a position, an orientation, a length, a width, a height, a depth, an area, a volume, a flight path, a motion, a weighting value, a mass parameter, an importance parameter, or a lighting parameter.

The method may further comprise determining, based on the at least one surface, secondary content suitable for placement on the at least one surface and inserting, into primary content, based on the at least one surface, the secondary content. The method may further comprise based on the at least one surface being a candidate for placement of secondary content, determining at least one output parameter associated with the at least one surface and adjusting the at least one output parameter associated with the at least one surface to maximize exposure of the at least one surface during output of the content.

The primary content may comprise at least one scene. The method may further comprise based on the at least one surface being a candidate for placement of secondary content, determining at least one output parameter associated with the at least one scene and adjusting the at least one output parameter associated with the at least one scene to maximize exposure of the at least one surface during output of the at least one scene.

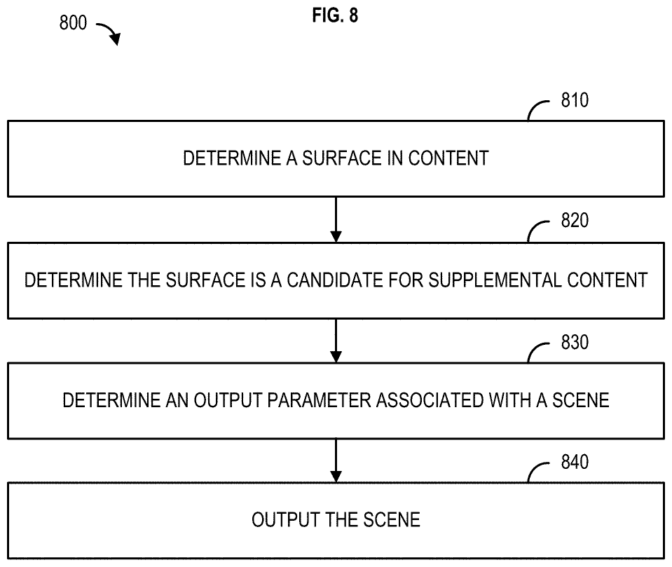

FIG. 8 shows a flowchart of a method 800 for content modification. The method may be carried out by any of, or any combination of, the devices describe herein such as, for example, the computing device 102 and/or, the secondary content device 104.

At step 810, at least one surface in at least one scene of content may be determined. For example, a computing device may receive primary content (e.g., from a primary content source). The primary content may comprise one or more content segments. The primary content may comprise a single content item, a portion of a content item (e.g., content fragment), a content stream, a multiplex that includes several content items, combinations thereof, and the like. The primary content may be accessed by users via applications, such as mobile applications, television applications, STB applications, gaming device applications, combinations thereof, and the like. An application may be a custom application (e.g., by content provider, for a specific device), a general content browser (e.g., web browser), an electronic program guide, combinations thereof, and the like. The primary content may comprise live-action content, animated content, digital content, and/or the like. The primary content may comprise one or more scenes. At least one scene of the one or more scenes may incorporate computer generated graphics (CGI). The primary content may comprise and/or otherwise be associated with one or more output parameters. The one or more output parameters may comprise information related to position, orientation, length, width, height, depth, area, volume, flight path, motion, weight, mass, importance (e.g., interest), lighting, one or more rules, and/or the like. For example, information related to position may comprise one or more coordinates (e.g., coordinates pairs or triplets) which define the at least one object.

At step 820, the computing device may determine that the at least on surface is a candidate for placement of secondary content. The secondary content may comprise one or more ads (e.g., the secondary content may comprise product placement content). For example, the computing device may determine a surface of interest in the primary content. The surface of interest may be a surface that is a candidate for insertion of secondary content. For example, the surface of interest may be a surface with a large area, a surface that remains visible to a viewer during a scene for an amount of time, a surface which is well lit, etc.

At step 830, the computing device may determine at least one output parameter associated with the at least one scene. For example, the computing device may determine the at least one output parameter associated with the at least one scene based on the at least one surface being a candidate for placement of the secondary content. For example, the at least one output parameter, may comprise a position, an orientation, a length, a width, a height, a depth, an area, a volume, a flight path, a motion, a weighting value, a mass parameter, an importance parameter, or a lighting parameter associated with the at least one scene.

At step 840, may output the at least one scene. For example, the computing device may send the scene to a downstream device such as the secondary content device, a user device such as a media device, a distribution device, or any other device. The at least one scene may comprise an adjusted at least one output parameter. The adjusted at least one output parameter may be associated with the at least one surface. For example the adjusted at least one output parameter may comprise an adjusted surface area, and adjusted lighting parameter, an adjusted flight path, or any other output parameter as described herein.

The method may further comprise adjusting the at least one output parameter. For example, the computing device may adjust the at least one output parameter associated with the scene in order to maximize exposure of the at least one surface during output of the primary content. For example, adjusting the at least one output parameter associated with the at least one surface may comprise changing at least one of: a position, an orientation, a length, a width, a height, a depth, an area, a volume, a flight path, a motion, a weighting value, a mass parameter, an importance parameter, or a lighting parameter associated with the scene. For example, the computing device may adjust the at least one output parameter associated with the at least one second object so as to maximize exposure of the at least one surface (e.g., the at least one first object). For example, the computing device may bring the area of interest into focus while making the remainder of the scene blurry.

The method may further comprise, based on the at least one surface being a candidate for placement of secondary content, determining at least one output parameter associated with the at least one surface and adjusting the at least one output parameter associated with the at least one surface to maximize exposure of the at least one surface during output of the content. The method may further comprise, based on the at least one surface being a candidate for placement of secondary content, determining at least one output parameter associated with at least one object associated with the at least one surface and adjusting the at least one output parameter associated with at least one object to maximize exposure of the at least one surface during output of the content.

The method may further comprise, based on the at least one surface being a candidate for placement of secondary content, determining at least one output parameter associated with the at least one surface adjusting the at least one output parameter associated with the at least one surface to maximize exposure of the at least one surface during output of the content.

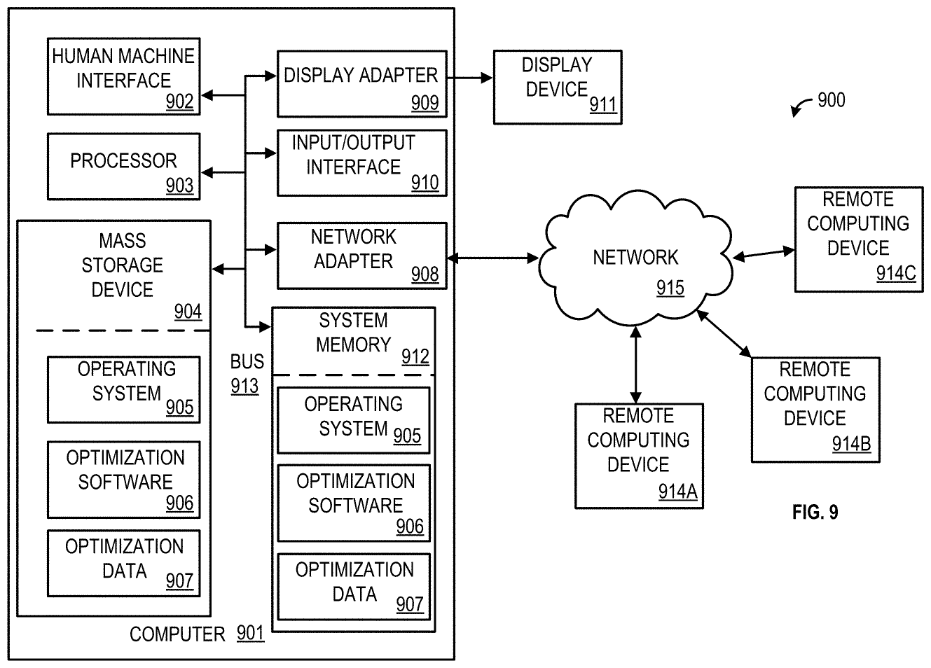

FIG. 9 shows a system 900 for content modification, the computing device 102 and/or the secondary content device 104 may be a computer 901 as shown in FIG. 9. The computer 901 may comprise one or more processors 903, a system memory 912, and a bus 913 that couples various system components including the one or more processors 903 to the system memory 912. In the case of multiple processors 903, the computer 901 may utilize parallel computing. The bus 913 is one or more of several possible types of bus structures, including a memory bus or memory controller, a peripheral bus, an accelerated graphics port, or local bus using any of a variety of bus architectures.

The computer 901 may operate on and/or comprise a variety of computer readable media (e.g., non-transitory). The readable media may be any available media that is accessible by the computer 901 and may comprise both volatile and non-volatile media, removable and non-removable media. The system memory 912 has computer readable media in the form of volatile memory, such as random access memory (RAM), and/or non-volatile memory, such as read only memory (ROM). The system memory 912 may store data such as the modification data 907 and/or program modules such as the operating system 905 and the modification software 906 that are accessible to and/or are operated on by the one or more processors 903. The modification software 906 may comprise the mesh module 230, the physics engine 232, the object recognition module 234, or the visibility module 236. The machine learning module may comprise one or more of the modification data 907 and/or the modification software 906.

The computer 901 may also comprise other removable/non-removable, volatile/non-volatile computer storage media. FIG. 9 shows the mass storage device 904 which may provide non-volatile storage of computer code, computer readable instructions, data structures, program modules, and other data for the computer 901. The mass storage device 904 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 904, such as the operating system 905 and the modification software 906. Each of the operating system 905 and the modification software 906 (or some combination thereof) may comprise elements of the program modules and the modification software 906. The modification data 907 may also be stored on the mass storage device 904. The modification data 907 may be stored in any of one or more databases. Such databases may be DB2®, Microsoft® Access, Microsoft® SQL Server, Oracle®, MySQL, PostgreSQL, and the like. The databases may be centralized or distributed across locations within the network 915.

A user may enter commands and information into the computer 901 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 903 via a human machine interface 902 that is coupled to the bus 913, but may be connected by other interface and bus structures, such as a parallel port, game port, an IEEE 1394 Port (also known as a Firewire port), a serial port, network adapter 908, and/or a universal serial bus (USB).

The display device 911 may also be connected to the bus 913 via an interface, such as the display adapter 909. It is contemplated that the computer 901 may comprise more than one display adapter 909 and the computer 901 may comprise more than one display device 911. The display device 911 may be a monitor, an LCD (Liquid Crystal Display), light emitting diode (LED) display, television, smart lens, smart glass, and/or a projector. In addition to the display device 911, other output peripheral devices may be components such as speakers (not shown) and a printer (not shown) which may be connected to the computer 901 via the Input/Output Interface 910. Any step and/or result of the methods may be output (or caused to be output) in any form to an output device. Such output may be any form of visual representation, including, but not limited to, textual, graphical, animation, audio, tactile, and the like. The display device 911 and computer 901 may be part of one device, or separate devices.

The computer 901 may operate in a networked environment using logical connections to one or more remote computing devices 914A,B,C. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 901 and a remote computing device 914A,B,C may be made via a network 915, such as a local area network (LAN) and/or a general wide area network (WAN). Such network connections may be through the network adapter 908. The network adapter 908 may be implemented in both wired and wireless environments. Such networking environments are conventional and commonplace in dwellings, offices, enterprise-wide computer networks, intranets, and the Internet.

Application programs and other executable program components such as the operating system 905 are shown herein as discrete blocks, although it is recognized that such programs and components reside at various times in different storage components of the computing device 901, and are executed by the one or more processors 903 of the computer. An implementation of the optimization software 906 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
determining, by a computing device, at least one surface in content;
based on determining the at least one surface, determining at least one output parameter associated with the at least one surface; and
outputting the content, wherein the content comprises an adjusted at least one output parameter.

2. The method of claim 1, further comprising adjusting, based on the at least one surface, the at least one output parameter to maximize exposure of the at least one surface during output of the content.

3. The method of claim 2, wherein adjusting the at least one output parameter is based on the secondary content.

4. The method of claim 2, wherein adjusting the at least one output parameter comprises changing at least one of: a position, an orientation, a length, a width, a height, a depth, an area, a volume, a flight path, a motion, a weighting value, a mass parameter, an importance parameter, or a lighting parameter.

5. The method of claim 1, further comprising:
determining, based on the at least one surface, secondary content, wherein the secondary content is configured for placement on the at least one surface; and
inserting, based on the at least one surface, the secondary content into the content.

6. The method of claim 1, wherein the at least one surface is associated with at least one object in the content, the method further comprising:
based on the at least one surface being a candidate for placement of secondary content, determining at least one output parameter associated with the at least one object; and
adjusting the at least one output parameter associated with at least one object to maximize exposure of the at least one surface during output of the content.

7. The method of claim 1, wherein the content comprises at least one scene, the method further comprising:
based on the at least one surface being a candidate for placement of secondary content, determining at least one output parameter associated with the at least one scene; and
adjusting the at least one output parameter associated with the at least one scene to maximize exposure of the at least one surface during output of the at least one scene.

8. A method comprising:
determining, by a computing device, from among a plurality of objects in a scene, at least one first object comprising at least one surface;
determining that the at least one surface is a candidate for placement of secondary content;
based on the at least one surface being a candidate for placement of secondary content, determining at least one output parameter associated with at least one second object in the scene; and
causing, according to the at least one output parameter, the scene to be output, wherein the scene comprises increased exposure of the at least one first object and reduced exposure of the at least one second object.

9. The method of claim 8, wherein causing the scene to be output comprises adjusting the at least one output parameter associated with the at least one second object to maximize exposure of the at least one surface during output of the secondary content.

10. The method of claim 8, further comprising:
determining, based on the at least one surface, secondary content suitable for placement on the at least one surface; and
inserting, into primary content, based on the at least one surface, the secondary content.

11. The method of claim 8, further comprising adjusting the at least one output parameter associated with the at least one surface comprises changing at least one of: a position, an orientation, a length, a width, a height, a depth, an area, a volume, a flight path, a motion, a weighting value, a mass parameter, an importance parameter, or a lighting parameter.

12. The method of claim 8, further comprising:
based on the at least one surface being a candidate for placement of secondary content, determining at least one output parameter associated with the at least one surface; and
adjusting the at least one output parameter associated with the at least one surface to maximize exposure of the at least one surface during output of the content.

13. The method of claim 8, wherein the content comprises at least one scene, the method further comprising:
based on the at least one surface being a candidate for placement of secondary content, determining at least one output parameter associated with the at least one scene; and
adjusting the at least one output parameter associated with the at least one scene to maximize exposure of the at least one surface during output of the at least one scene.

14. The method of claim 13, wherein adjusting the at least one output parameter associated with the at least one scene comprises changing at least one of: a position, an orientation, a length, a width, a height, a depth, an area, a volume, a flight path, a motion, a weighting value, a mass parameter, an importance parameter, or a lighting parameter.

15. A method comprising:
determining, by a computing device, at least one surface in at least one scene of content;
determining that the at least one surface is a candidate for placement of secondary content;
based on the at least one surface being a candidate for placement of secondary content, determining at least one output parameter associated with the at least one scene; and
outputting the at least one scene, wherein the at least one scene comprises at least one output parameter.

16. The method of claim 15, further comprising adjusting the at least one output parameter associated with the at least one scene to maximize exposure of the at least one surface during output of the at least one scene.

17. The method of claim 15, further comprising:
based on the at least one surface being a candidate for placement of secondary content, determining at least one output parameter associated with the at least one surface; and
adjusting the at least one output parameter associated with the at least one surface to maximize exposure of the at least one surface during output of the content.

18. The method of claim 15, further comprising:
based on the at least one surface being a candidate for placement of secondary content, determining at least one output parameter associated with at least one object associated with the at least one surface; and
adjusting the at least one output parameter associated with at least one object to maximize exposure of the at least one surface during output of the content.

19. The method of claim 15, further comprising:
based on the at least one surface being a candidate for placement of secondary content, determining at least one output parameter associated with the at least one surface; and
adjusting the at least one output parameter associated with the at least one surface to maximize exposure of the at least one surface during output of the content.

20. The method of claim 15, further comprising:
based on the at least one surface being a candidate for placement of secondary content, determining at least one output parameter associated with at least one object associated with the at least one surface; and
adjusting the at least one output parameter associated with at least one object to maximize exposure of the at least one surface during output of the content.
